(19) United States
(12) Patent Application Publication
(10) Pub. No.: US 2004/0152384 A1
(43) Pub. Date: Aug. 5, 2004

(54) Self-windable adhesive tape

(76) Inventor: Dagmar Ommerborn, Wuppertal (DE)

Correspondence Address: Merchant & Gould P.C., P.O. Box 2903, Minneapolis, MN, 55402-0903, US

(21) Appl. No.: 10/743,859

(22) Filed: Dec. 22, 2003

(30) Foreign Application Priority Data
Dec. 23, 2002 (DE) DE 202 20 103.1

(51) Int. Cl. B32B 5/02

(52) U.S. Cl. 442/151; 428/340; 428/343

(57) ABSTRACT

The invention relates to a self-windable adhesive tape comprising a tape-shaped carrier which consists of a knit (G). To achieve good hand-tearability combined with less costly and inconvenient manufacture, it is proposed that the carrier be provided on one side with a directly applied pressure-sensitive adhesive coating. The carrier in question has a material thickness in the range from 0.1 to 1.0 mm and a specific basis weight of 40-200 g/m² and is pileless. The adhesive coating has a grammage of 20-150 g/m². In a preferred embodiment, the lapping of the knit (G) is formed by a combination of threads (3) in a velvet construction and threads (4) in a pillar stitch construction and includes nonrunning stitches (MB).

The present invention relates to a self-windable adhesive tape comprising a tape-shaped carrier which consists of a knit fabric and has been provided on one side with a pressure-sensitive adhesive coating which has been applied directly to the carrier.

The German utility model DE 299 00 924 U1 describes a similar velour adhesive tape for attachment to a complementary hook and loop closure portion, especially for bandaging elongate good, such as a cable set for an automobile, which comprises a tape-shaped textile carrier having an upper surface comprising hookable loops and a lower surface comprising a priming layer and a self-adhesive layer applied atop the priming layer. The priming layer has a specific basis weight of less than about 20 g/m². The carrier can consist of a warp knit. Carrier features disclosed are a material thickness range from about 0.8 to 2.0 mm and a specific basis weight range of about 120-200 g/m² and especially about 140-180 g/m². The known adhesive tape is a relatively strong material in that a breaking strength of about 100-200 N/cm is disclosed for the carrier in the longitudinal direction.

DE 101 02 927 A1 describes an adhesive tape of the kind described at the beginning that is an adhesive tape for wrapping for example cables in automobiles, pipes or the like mostly elongate objects. The adhesive tape's fundamental construction likewise comprises a velour-based carrier tape and an adhesive coating applied atop all or some of the carrier tape. The adhesive tape can be made on the basis of a knit. Because the carrier tape has a stitch density in the range from about 25 000 per dm² to 50 000 per dm², the adhesive coating can be applied directly atop the carrier tape; that is, no priming layer is provided, in contrast to the adhesive tape of DE 299 00 924 U1. Again, this known adhesive tape is a relatively strong material since the carrier likewise has a breaking strength of about 100-200 N/cm in the longitudinal direction.

Textile fabrics can basically be divided into flat fabrics (wovens, nonwovens, flat knits) and pile fabrics (velour, velvet, plush, etc). The materials mentioned in the cited references as carrier materials for the adhesive tapes described are velours, which have a pile. They are therefore also referred to as pile fabrics which the German industrial standard DIN 62055 defines as textile sheet materials having pile-forming threads or fibers projecting from a base layer on one or both sides. A pile layer can be disposed on one or both sides. A velour is in particular a one-sided pile fabric having an open pile of low to medium pile layer thickness, pile height being >2 mm and 10 mm.

Adhesive tapes can be processed either by hand or via winding machines. For hand processing, easy tearability is desirable in some sectors in order that the risk of injury due to the requisite use of knives or cutting tools may be avoided. Fabrication times can also be reduced in this way. Tapes are torn at right angles to the direction of movement of the tape, and the torn edge produced should be clean and straight. Necking (narrowing) of the material during tearing is as undesirable as are frayed and fibrous torn edges. The adhesive tapes described above are not hand tearable because of their high strength.

Textile adhesive tapes which are hand tearable currently utilize the following carriers: viscose rayon staple wovens, viscose rayon staple wovens comprising an acrylate coating, polyester wovens, polyester stitch-bondeds, hydroentangled nonwovens, needled nonwovens, etc.

Especially viscose rayon staple woven adhesive tapes have the disadvantage that the viscose rayon staple woven makes them expensive and rottable. This also holds for viscose rayon staple wovens comprising an acrylate coating in that the acrylate coating on the carrier additionally increases the fabrication effort.

Polyester ester woven adhesive tapes likewise have the disadvantage of being expensive because of the fabric used, the cost reflecting the sheer cost and inconvenience of producing the tape including the sheer cost and inconvenience of producing the carrier material. These tapes may be hand tearable or not, depending on the yarn type used.

Polyester and especially PET woven adhesive tapes are essentially characterized by high breaking strength. There are individual cases of products which are hand tearable, but these wovens have a very open and hence permeable structure. This property represents a very profound obstacle to coating with adhesive, especially with UV-crosslinkable acrylate adhesives, since such adhesives are applied to the fabric uncrosslinked and at high flowability.

PET stitch-bondeds have the disadvantage of having a relatively low strength. When materials of comparatively high strength are needed, the basis weight has to be increased, which has negative repercussions for tearability and cost. Moreover, layer thickness increases appreciably when the basis weight is increased, so that these tapes cannot be used universally.

Spunbondeds are fiber webs composed of filament fiber which are formed directly from a spinning dope in a continuous process. The production process is made up of a plurality of consecutive subsidiary processes. These include extruding and melting the polymer, spinning the fiber, drawing the fiber, laying the fiber down on a conveyor belt and consolidating the web. The last operation can be done mechanically (needling), thermally (calender) or chemically (binder). Spunbonded-based carriers are generally impossible or very difficult to tear by hand, yet possess only low strengths. In addition, they badly neck in the course of being torn off, which is not desired by users.

It is an object of the present invention to provide a self-windable adhesive tape of the kind mentioned at the beginning that is hand tearable as well as less costly and inconvenient to manufacture.

This object is achieved by an adhesive tape of the type mentioned at the beginning when the carrier has a material thickness in the range from 0.1 to 1.0 mm and a specific basis weight of 40-200 g/m² and is pileless, the adhesive coating having a grammage of 20-150 g/m².

An essential difference between the warp knits used in the present invention and the velour of known use is that the velour has an open pile, whereas the knit described herein in essence is a flat fabric. Knits of this kind have hitherto been considered unsuitable for use as carrier materials for adhesive tapes. Yet it has been found that, surprisingly, such an inexpensively producible material, when it has a material thickness in the range from 0.1 to 1.0 mm and a specific basis weight of 40-200 g/m², not only provides hand tearability to the adhesive tape, but also makes it possible for the adhesive coating to be applied to the carrier without priming, the knit providing the carrier with at least one side which is smooth (visually indicated by a lustrous appearance) and which ensures optimal bonding of the adhesive to the base.

The carrier of the adhesive tape of the present invention may comprise polyester fiber yarn, preferably composed of PET, other synthetic fiber yarns, as of polyamide or polyacrylonitrile, or a blend fiber yarn of synthetic fibers, preferably PET/PA. In preferred embodiments, the specific basis weight of the carrier may be 70-110 g/m² and the material thickness of the carrier may be in the range from about 0.2 mm to 0.7 mm.

The pressure-sensitive adhesives used may be acrylate adhesives, especially UV-crosslinkable acrylate adhesives, synthetic and also natural rubber adhesives, the method of application used depending on the permeability of the carrier material.

A first possible application method which may be mentioned is direct coating of the carrier. Known direct coating processes are roller coating and die application, especially the latter appearing to be particularly suitable. In roll application, the flowable adhesive is metered via a heated roll system to be applied in the desired layer thickness. In die application, the adhesive is forced by means of a pump, especially a geared pump, through a GID slot die which can rest on the carrier material. The die ensures that the adhesive is directly applied to the carrier material in a state of uniform dispersion over the area. Direct coatings will always be advantageous when the carrier is sufficiently close, i.e., when migration of the adhesives through the carrier during coating can be ruled out. In addition, the carrier has to possess sufficient thermal stability.

The adhesive can also be applied in a coating process without application of pressure, such as the curtain coating process. In this process, an uninterrupted film of adhesive descends onto the substrate. This ensures uniform thickness and hence grammage for the adhesive layer. The amount of adhesive applied is only as much as needed. Preference is given to a grammage of not more than 65 g/m².

Finally, it is also possible to use indirect coating processes, for example transfer coating by means of an intermediate substrate. First a siliconized interliner (silconized paper or siliconized polymer film, such as polyolefin film or polyester film) is coated. Then the carrier material is laminated on. To produce a self-wound adhesive tape by this process, however, the interliner, which serves as a process aid, has to be peeled off again from the carrier material, and wound up separately, at the reel-making stage.

Transfer coatings and coatings applied without pressure are preferably used in the case of carriers which are thermally sensitive and/or permeable to the adhesive. Carrier damage and coating roll contamination is thus avoided during the coating operation.

The knit used according to the present invention may in principle utilize any one of the different pattern notations. However, as already mentioned, it is important to construct at least one smooth carrier side in order that the desired adhesive bonding may be achieved. One important aspect governing the choice of fabric construction is that, especially when transfer coating is employed, there will also be a difference in the bonding of the adhesive on the two sides of a carrier which has two differently constructed sides, i.e., a smooth side and a more rib-looped side, as it will be the case when a right/left (knit/purl stitch) construction plain lappings is used. In general, the adhesive will adhere distinctly better to the smooth side of the material than to the slightly ridged side. This effect serves to prevent the adhesive transferring from one side of the material to the other when the tape is self-wound. Otherwise, this transferring of the adhesive to textile carriers is frequently observed in the case of UV-crosslinked adhesives and transfer coating. When the application of the adhesive is carried out as a direct coating process, it may be preferable to use other kinds of interlacing, for example a one-by-one rib knitted fabric.

The carrier may advantageously have a stitch density of at least 80 per dm and preferably in the range from about 195 per dm to 250 per dm and a wale density of at least 80 per dm and preferably in the range from about 110 per dm to 150 per dm.

A less suitable choice for manufacturing an adhesive tape according to the present invention appears to be to use very soft, elastic knits. This is because the possible applications for the various carriers are determined not only by a certain type of lapping or construction, but also to a marked degree by their extensibility. For this reason, the carrier materials preferred according to the present invention are warp knits and not weft knits. The last-mentioned materials are generally too elastic, unless additional weft threads or other stabilizing construction elements are used. The (breaking) extension of the carrier in an adhesive tape of the present invention should therefore ideally be less than 60%. Particular preference is given to a range of 10-25%.

Adhesive tapes of the present invention may preferably be produced such that they are hand tearable in the cross direction. But the breaking strength in the longitudinal direction should be at least 15 N/cm and preferably be in the range of 15-70 N/cm.

Reels of adhesive tapes of the present invention may be produced at the final stage of the manufacturing operation by means of various processes, although in each case a coated mother reel forms the starting point. In the first process, the slicing of reels from prefabricated coils, the first step is to fabricate coils of a predetermined length from a mother reel and then slice them down to the desired width. In the second process, the direct cutting of reels, the coated carrier material is reeled off, sliced into small strips and finally wound up to short narrow reels in one operation. In both the first and in the second process, the later forces needed to unwind the adhesive tape of the present invention off the reel can be set via the pulling tension of a winding machine.

Further advantageous embodiments of the invention are contained in the subsidiary claims and the specific description which follows. Two illustrative embodiments are used to more closely describe the invention.

The invention will now be more particularly described by way of example with reference to the drawing, where

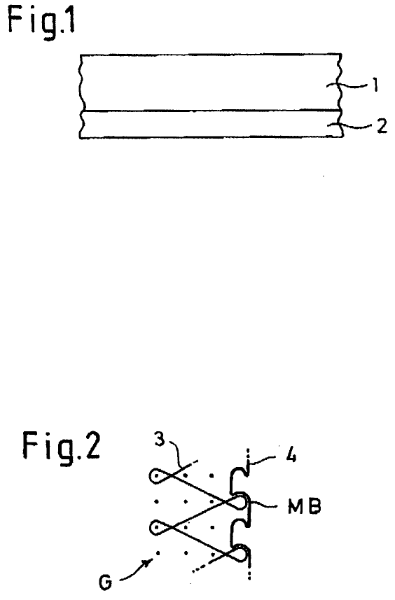

FIG. 1 shows a cross section through an inventive adhesive tape, and

FIG. 2 shows a lapping diagram for a knit used according to the present invention as a carrier material.

### EXAMPLE 1

A hand-tearable cable winding tape which, in line with the construction depicted in FIG. 1, comprised a tape-shaped carrier 1 consisting of a knit (identified as G in FIG. 2) and a pressure-sensitive adhesive coating 2 directly applied to one side of the carrier 1, was produced using a PET warp knit having a specific basis weight of about 90 g/m² as a material for the carrier 1 and a UV-crosslinked acrylate adhesive applied at a grammage of about 70 g/m² as an adhesive coating 2.

The knit G of the carrier 1 was in particular a tearable knit G which was constructed to include fixed stitches (identified as MB in FIG. 2). Such a form of lapping could also be referred to as a combination of the basic lapping structures known as pillar stitch and velvet.

FIG. 2 depicts by way of example a lapping diagram of a knit G comprising such a combination. In detail, the construction is a counter-lapped two-thread system plain pillar stitch/velvet lapping. The left-hand thread 3 (i.e., the left-hand fiber) is assigned the basic type of construction known as velvet and comprises closed foot structures. The right-hand thread 4 (i.e., the right-hand fiber) must be assigned the basic type known as pillar stitch. It comprises a single-stitch open lap.

The number of stitches of the knit G used was 21 per 1 cm+/−1 stitch, the number of wales being 12 per 1 cm+/−1 wale. Yarn linear density was 50 dtex. The adhesive tape of the present invention had altogether the properties recited below in Table 1.

TABLE 1

| Feature | Method | Unit | Value |
|---|---|---|---|
| Material | | — | Warp knit |
| Yarn | | — | Polyester yarn |
| Basis weight | EN 2286-2 | g/m² | 90 |
| Adhesive add-on weight | EN 2286-2 | g/m² | 70 |
| Material thickness (D) | EN 1942 | mm | approx. 0.3 |
| Mechanical properties | | | |
| Breaking extension MD | EN 1941 | % | approx. 25 |
| Breaking strength MD | EN 1940 | N/cm | approx. 45 |
| Bond strength, steel | EN 1939 | N/cm | >3 |

### EXAMPLE 2

A textile adhesive tape which has breaking strength and which likewise, in line with the construction depicted in FIG. 1, comprised a tape-shaped carrier 1 consisting of a knit G and a pressure-sensitive adhesive coating 2 directly applied to one side of the carrier 1, was produced using a PET warp knit having a specific basis weight of about 110 g/m² as a material for the carrier 1 and a UV-crosslinked acrylate adhesive applied at a grammage of about 80 g/m² as an adhesive coating 2.

The adhesive tape of the present invention had the properties recited below in Table 2.

TABLE 2

| Feature | Method | Unit | Value |
|---|---|---|---|
| Material | | — | Warp knit |
| Yarn | | — | Polyester yarn |
| Basis weight | EN 2286-2 | g/m² | 110 |
| Adhesive add-on weight | EN 2286-2 | g/m² | 80 |
| Material thickness (D) | EN 1942 | mm | approx. 0.4 |
| Mechanical properties | | | |
| Breaking extension MD | EN 1941 | % | approx. 20 |
| Breaking strength MD | EN 1940 | N/cm | approx. 65 |
| Bond strength, steel | EN 1939 | N/cm | >3 |

The invention is not limited to the illustrative embodiments described, but includes all embodiments which act in the same way as the invention. Thus, as mentioned earlier, the carrier material 1 may also be a knit G having a different interlacing design, such as for example having a pure or combined (pileless) tricot construction. The linear density of the fibers 3, 4 of the knit G may preferably be in the range from about 20 dtex to 70 dtex, especially in the range from 25 to 55 dtex and more preferably in the range from 30 to 45 dtex.

A person skilled in the art is able to complement the invention with additional advantageous measures without going outside the realm of the invention. Thus, the adhesive tape according to the present invention may for example optionally be provided with a flame-retardant finish.

Nor is the invention limited to the features combination defined in claim 1, but can also be defined by any desired other combination of certain features of all individual features disclosed in total. This means that any individual feature of claim 1 can be omitted or be replaced by at least one feature disclosed elsewhere. In this regard, claim 1 must merely be understood as a first attempt to formulate an invention.

List of Reference Symbols

1 Carrier

2 Adhesive coating

3 Threads of 1 of the basic type of construction known as velvet

G knit

MB fixed stitch

1. A self-windable adhesive tape comprising a tape-shaped carrier (1) which consists of a knit (G) and has been provided on one side with a pressure-sensitive adhesive coating (2) which has been applied directly to the carrier (1)
wherein the carrier (1) has a material thickness (D) in the range from 0.1 to 1.0 mm and a specific basis weight of 40-200 g/m² and is pileless, the adhesive coating (2) having a grammage of 20-150 g/m².

2. An adhesive tape according to claim 1,
wherein the knit (G) of the carrier (1) is a warp knit.

3. An adhesive tape according to claim 1 or 2,
wherein the specific basis weight of the carrier (1) is 70-110 g/m².

4. An adhesive tape according to any of claims 1 to 3,
wherein the adhesive tape is hand tearable in the cross direction.

5. An adhesive tape according to any of claims 1 to 4,
wherein the breaking strength in the longitudinal direction is at least 15 N/cm and is preferably in the range of 15-70 N/cm.

6. An adhesive tape according to any of claims 1 to 5,
wherein the breaking extension in the longitudinal direction is not more than 60% and is preferably in the range of 10-25%.

7. An adhesive tape according to any of claims 1 to 6,
wherein the adhesive coating (2) comprises a natural or synthetic pressure-sensitive adhesive which comprises rubber or acrylate and is preferably UV crosslinkable.

8. An adhesive tape according to any of claims 1 to 7,
wherein the adhesive coating (2) has been applied atop the carrier at a grammage of not more than 65 g/m².

9. An adhesive tape according to any one of claims 1 to 8,
wherein the material thickness (D) of the carrier (1) is in the range from about 0.2 mm to 0.7 mm.

10. An adhesive tape according to any of claims 1 to 9,
wherein the carrier (1) has a stitch density of at least 80 per dm and preferably in the range from about 195 per dm to 250 per dm.

11. An adhesive tape according to any one of claims 1 to 10,
wherein the carrier (1) has a wale density of at least 80 per dm and preferably in the range from about 110 per dm to 150 per dm.

12. An adhesive tape according to any one of claims 1 to 11,
wherein the carrier (1) comprises polyester fiber yarn, preferably composed of PET, other synthetic fiber yarns, as of polyamide or polyacrylonitrile, or a blend fiber yarn of synthetic fibers, preferably PET/PA.

13. An adhesive tape according to any one of claims 1 to 12,
wherein the knit (G) is formed from a two-yarn system (3, 4).

14. An adhesive tape according to any of claims 1 to 13,
wherein the lapping of the knit (G) is a plain lapping or a rib lapping, the surface of the carrier (1) being substantially smooth on that side to which the adhesive coating (2) is applied.

15. An adhesive tape according to any of claims 1 to 14,
wherein the lapping of the knit (G) includes fixed stitches (MB) and is in particular describable in terms of a combination of threads (3) in a velvet construction and threads (4) in a pillar stitch construction.

16. An adhesive tape according to any of claims 1 to 15,
wherein the linear density of the fibers (3, 4) of the knit (G) is in the range from about 20 dtex to 70 dtex, especially in the range from 25 to 55 dtex and more preferably in the range from 30 to 45 dtex.

17. An adhesive tape according to any of claims 1 to 16,
wherein the adhesive tape has an EN 1939 bond strength on steel of more than 3 N/cm.
